(19) United States
(12) Patent Application Publication
(10) Pub. No.: US 2017/0368548 A1
(43) Pub. Date: Dec. 28, 2017

(54) MICROFLUIDIC CHIP COMPRISING A FUNCTIONAL AREA, WHICH IS COVERED BY A FLEXIBLE OR DEFORMABLE COVER, AND MICROFLUIDIC SYSTEM

(71) Applicant: m2p-labs GmbH, Baesweiler (DE)

(72) Inventors: Niklas FRISCHE, Geilenkirchen (DE); Anna KRESS, Aachen (DE); Thomas MEINEN, Pullach i. Isartal (DE); Carsten MUELLER, Herzogenrath (DE)

(73) Assignee: m2p-labs GmbH, Baesweiler (DE)

(21) Appl. No.: 15/632,659

(22) Filed: Jun. 26, 2017

(30) Foreign Application Priority Data
Jun. 27, 2016 (DE) 10 2016 007 747.6
Nov. 25, 2016 (DE) 10 2016 014 056.9

(51) Int. Cl. B01L 3/00

(52) U.S. Cl. CPC B01L 3/502707; B01L 3/5023; B01L 3/502746

(57) ABSTRACT

A microfluidic chip includes a functional area, which is covered by a flexible or deformable cover. The cover has an expansion limiter. This expansion limiter can for example be embodied as a stable plate including one or more than one opening. The expansion limiter may be fixedly connected to the cover.

### CROSS REFERENCE TO RELATED APPLICATIONS

Applicant claims priority under 35 U.S.C. §119 of German Application Nos. 10 2016 007 747.6 filed on Jun. 27, 2016 and 10 2016 014 056.9 filed on Nov. 25, 2016, the disclosures of which are incorporated by reference.

### BACKGROUND OF THE INVENTION

### 1. Field of the Invention

The invention relates to a microfluidic chip comprising a functional area, which is covered by a flexible or deformable cover.

### 2. Description of the Related Art

The concept of miniaturization is applied to chemical and biological procedures under the name “Lab-on-a-Chip”. Lab-on-a-Chip means implementing expensive and extensive laboratory procedures into an integrated chip system and to thus provide novel tools, which overcome the limitations of stationary laboratories, for biotechnology, analytical, pharmaceutical and clinical chemistry, for environmental analysis, food chemistry, etc.

Microfluidics is the technical basis for the miniaturization of laboratory procedures for Lab-on-Chip systems. “Lab-on-Chip” thus identifies a microfluidic system, which combines the entire functionality of a macroscopic laboratory on a small surface, which fits in the palm of a hand.

### SUMMARY OF THE INVENTION

In order to satisfy the requirements of quantity, throughput and productivity, which dominate in particular in the increasingly industrial use of microfluidics, the invention relates in particular to microfluidic systems comprising polymeric materials. They can be processed simply by means of standard replication processes, such as micro-injection molding or hot stamping and allow for a production of microfluidic components, which can be scaled well and which is cost-efficient. In addition, the smaller process complexity in the component production as well as more freedom with respect to the design, are also arguments for the use of polymeric materials. Today, a plurality of polymers is available on the market, which are on principle suitable for the broad use in industrial microfluidic applications and which meet a large variety of demands, due to their qualitative properties, such as high purity, optical transparency, biocompatibility, chemical resistance, etc.

The invention furthermore predominantly relates to systems, which make it possible to allow a very large number of microfluidic processes to run simultaneously in a controlled manner, e.g. parallel high-throughput screening, upscaling by parallel production. Parallelization is associated with high demands on the functional quality of microfluidic systems, which must not be differ with respect to the process conditions, such as pressure, temperature, mass flow, etc. and operational safety during operation.

The closure of the function-bearing structures in the polymer body, which are still open after the injection molding or stamping process, against the outside world and the liquid-tight sealing of the fluidic system components (e.g. microchannels) relative to one another, is of significant importance with regard to the practical suitability.

On principle, this process, which is also identified as “capping”, takes place through thin polymer films, the capping films, which are applied to the surface by means of different joining processes, such as, for example, concealing, laminating, adhesion, welding and which form a sandwich composite, the microfluidic chip, with the structured polymer body, the bottom. The most important goal is thereby the establishing of a material connection between bottom and capping film, which must fulfill tightness and connection function equally.

When being used, the elasticity or softness, respectively, of the capping film can have a disadvantageous effect, because it is resilient in internally or externally induced positive or negative pressure changes, can expand or sink. This results in unwanted volume changes in the fluidic system. The associated risk of damages to the material compound, which typically reveals itself in the form of partial detaching/lift-off of the capping film on the edges of the microfluidic structures, and which can lead to undefined changes to the fill volume or to a leakage in the fluidic system, respectively, it also particularly critical.

The elasticity of the capping films, however, is not unwanted in any event, but can also be utilized specifically. When dealing with the active control of the liquid transport in microfluidic systems, the capping films can partially be embodied as elastic diaphragms for active components, such as valves, pumps or other functional elements, which can carry out lifting movements, for example by means of pneumatics acting from the outside, to displace and mobilize liquid or to open and close channels to control liquid flows in the microfluidic system.

If partial surfaces of the capping films are used as actively moved diaphragms for controlling purposes, it goes without saying that, due to the additional mechanical stress at that location, particular attention needs to be paid to a correspondingly stressable material composition, in order to avoid the problems associated with the above-mentioned possible detaching of the capping film. The requirements described herein represent a major challenge for the mounting and connection technology, because the joining process must be carried out particularly cautiously on the one hand so as not to damage the sensitive microfluidic structures or function-bearing materials, respectively, and because a high quality of the compound must be ensured on the other hand.

In addition, a further risk is that a repeated expansion of the areas of the capping film, which form the actively moved elastic diaphragms, can lead to an exceeding of the yield limit and thus to an irreversible deformation of the material in the form of a diaphragm sagging, which has a negative impact both on the volumetric accuracy and on the correct control function.

The target conflicts, which are created when the constructive and functional demands are to be aligned with the properties of the used materials and the technical possibilities of the mounting and connection technology, which, in practice, can hardly be bridged, become clear from the statements at this point.

This object is solved by means of a microfluidic chip comprising a functional area, which is covered by a flexible or deformable cover, wherein the cover has an expansion limiter, and a microfluidic system comprising such microfluidic chip, wherein the functional area has microfluidic control elements.

The subject matter of the invention is a component, which is identified as expansion limiter, which prevents an uncontrolled expansion of capping films or diaphragms, respectively, and which mechanically relieves the material bonding between bottom and capping film of microfluidic chips. This expansion limiter can completely eliminate the above-described problems in many applications.

The expansion limiter should bear against the cover plan and can be a stable film, for example. It is advantageous, if the expansion limiter is a stable plate comprising one or a plurality of openings.

This expansion limiter can be placed onto the cover and can be pushed onto the cover over a further element. It is advantageous, however, when the expansion limiter is fixedly connected to the cover.

It is proposed with regard to this that the expansion limiter is adhered to the cover. However, it can also be embodied in one piece with the cover, in that the cover has an increased thickness for example in the areas outside of the openings.

A simple setup provides for the cover to be fixedly connected to the functional area. For this purpose, the cover can be adhered to the functional area.

The cover can be a diaphragm or a film or can be configured of different elements or areas, which has a diaphragm or a film or a plurality of diaphragms and/or a plurality of films.

A specific embodiment provides for the microfluidic chip to have different active and/or passive functional areas, which are in each case covered by different covers.

For embodying a microfluidic chip system, it is proposed for a pneumatic adapter to be arranged on the microfluidic chip. This pneumatic adapter has control elements, which act on a functional area.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a sandwich structure of a microfluidic chip,

FIG. 2 shows the structure of a microfluidic cultivation platform,

FIG. 3 shows the cultivation platform shown in FIG. 2 in composite form,

FIG. 4 shows the pneumatically controllable diaphragm surface comprising an increased detail,

FIG. 5 shows a pneumatic adapter for the diaphragm actuation,

FIG. 6 shows a fluidic chip comprising an expansion limiter and

FIG. 7 shows an increased illustration of an expansion limiter.

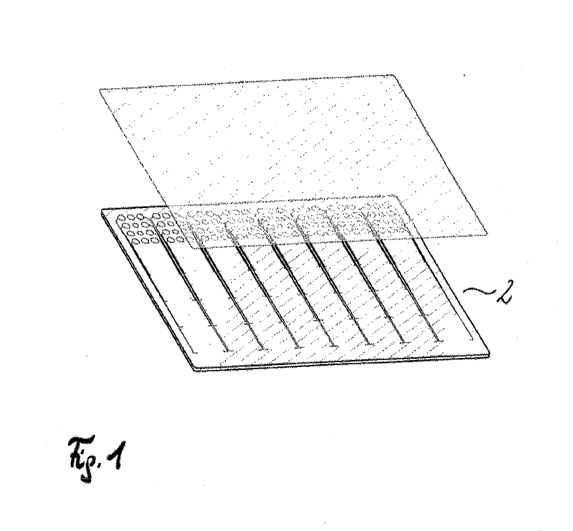

### DETAILED DESCRIPTION OF PREFERRED EMBODIMENTS

The mode of operation is explained by means of a microfluidic chip 2, which is joined to a microtiter plate 1. In connection with control elements 9 of a corresponding pneumatic adapter 16, this combination represents an automated cultivation platform.

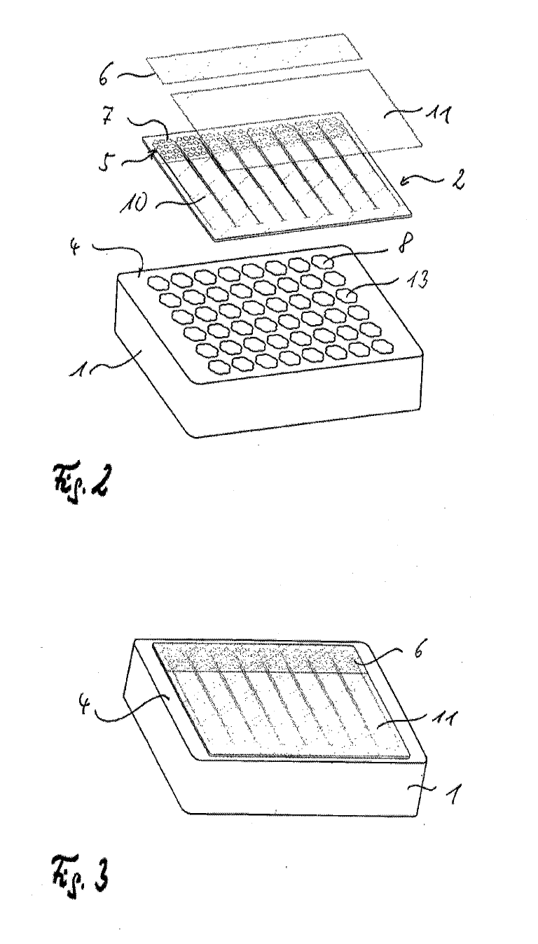

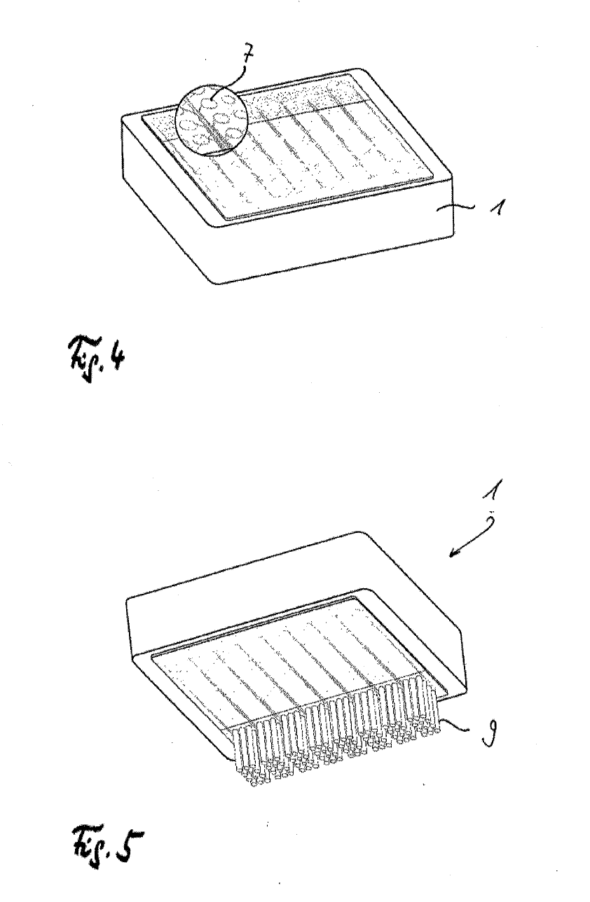

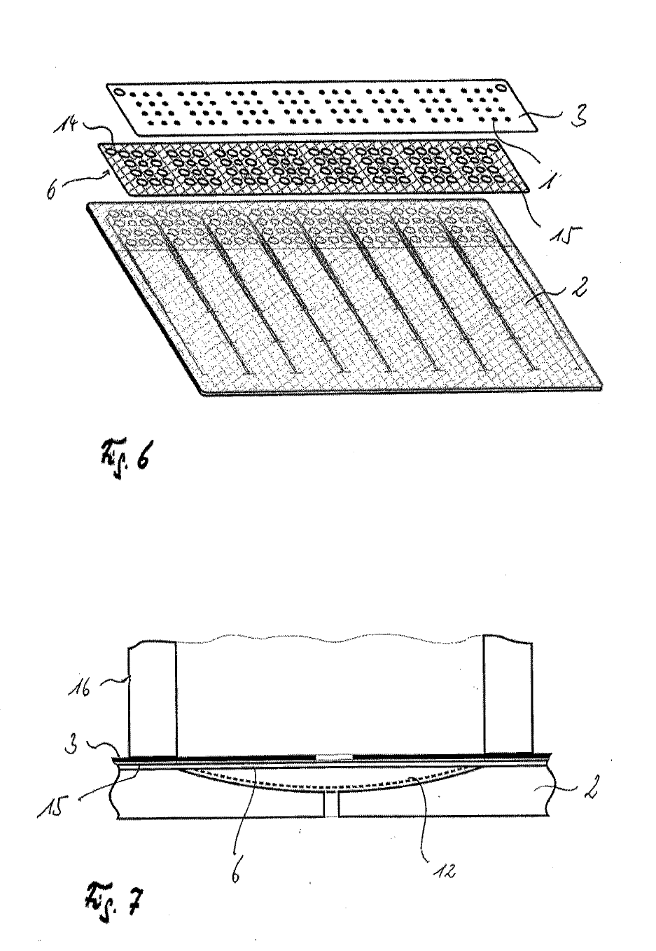

The preferred embodiment consists of the microfluidic chip 2, which is embodied as polymer body comprising microfluidic structures and which is fastened to the underside 4 of the microtiter plate 1, and comprises two functional areas: A narrow functional area 5, which is closed by the flexible or deformable cover, which is embodied as capping film 6, includes microfluidic valves 7 (only numbered in an exemplary manner), for controlling the fluid flows from the fluid reservoirs 8 (only numbered in an exemplary manner), which are located thereabove, arranged in the microtiter plate 1. FIGS. 2 to 4 illustrate the microtiter plate 1 below the microfluidic chip 2. In practice, however, the microfluidic chip 2 is arranged below the microtiter plate 1.

Due to the fact that the capping film 6 in the narrower area 5 serves as diaphragm 12 for the control elements 9 (only numbered in an exemplary manner), the capping film 6 must have corresponding mechanical properties in particular with regard to deformability. Microfluidic channels (not shown), which, among others, lead into the reaction chambers (wells) 13 (only numbered in an exemplary manner) of the microtiter plate 1 arranged thereabove, are located downstream from the larger passive functional area 10, which the capping film 11 covers.

The arrangement of the diaphragm surfaces 12 and of the control elements 9 of the pneumatic adapter 16, which is pressed against the microfluidic chip 1 by means of a corresponding clamping device and which allows for the individual control of each individual diaphragm via a pneumatic line of the control elements 9, is shown in FIG. 5.

In this example of use, the expansion limiter 3 consists of a thin perforated sheet steel—or in the alternative of a corresponding plastic film—the outer dimensions of which correspond to those of the capping film 6 and on which the positions of the openings 17 (only numbered in an exemplary manner), which are embodied as holes, correspond to the position of the valves 7 in the microfluidic chip 2. The attachment of the expansion limiter 3 to the underside 14 of the capping film 6 is carried out here by means of a correspondingly structured, very thin adhesive film. 15. The adhesive film is designed in such a way that it isolates the individual holes on the hole positions 13 and valves 7, which in each case correspond, in an air-tight manner.

The effect of the expansion limiter 3 primarily consists in that it prevents every unwanted expansion of the capping film 6, which is embodied as diaphragm 12, so that no undefined changes to the diaphragm geometry, such as, e.g. sagging, can occur. In the position shown in FIG. 7, the diaphragm 12 can only move downwards. The upwards expansion is prevented by means of the expansion limiter 3. A high volumetric accuracy of the fluidic system is ensured through this. The expansion limiter 3 furthermore relieves the connection between the capping film 6 and the bottom of the microfluidic chip 2 of mechanical stress, whereby the risk of detachment of the capping film 6 is effectively prevented.

Although only a few embodiments of the present invention have been shown and described, it is to be understood that many changes and modifications may be made thereunto without departing from the spirit and scope of the invention.

What is claimed is:

1. A microfluidic chip (2) comprising a functional area (5), which is covered by a flexible or deformable cover (6), wherein the cover (6) has an expansion limiter (3).

2. The microfluidic chip according to claim 1, wherein the expansion limiter (3) is a stable plate comprising one or a plurality of openings (17).

3. The microfluidic chip according to claim 1, wherein the expansion limiter (3) is fixedly connected to the cover (6).

4. The microfluidic chip according to claim 1, wherein the expansion limiter (3) is adhered to the cover (6).

5. The microfluidic chip according to claim 1, wherein the cover (6) is fixedly connected to the functional area (5).

6. The microfluidic chip according to claim 1, wherein the cover (6) is adhered to the functional area (5).

7. The microfluidic chip according to claim 1, wherein the cover has a diaphragm (12) or a film.

8. The microfluidic chip according to claim 1, wherein it has different active and/or passive functional areas (5, 10), which are in each case covered by different covers (6, 11).

9. A microfluidic chip system comprising a microfluidic chip according to claim 1, wherein the functional area (5) has microfluidic control elements (9).

10. The microfluidic chip system according to claim 9, wherein a pneumatic adapter (16) is arranged on the microfluidic chip (2).
